(19) United States
(12) Patent Application Publication
(10) Pub. No.: US 2026/0339786 A1
(43) Pub. Date: Oct. 29, 2026

(54) System and Method for Storage Optimization of Artificial Intelligence (AI) Workloads

(71) Applicant: Dell Products L.P., Round Rock, TX (US)

(72) Inventors: Shaul Dar, Petach Tikva (IL); Onur Celebioglu, Austin, TX (US); Gaurav Chawla, Austin, TX (US); John T. Cardente, Milford, MA (US); Jason J. Duquette, Sturbridge, MA (US)

(21) Appl. No.: 19/187,205

(22) Filed: Apr. 23, 2025

(51) Int. Cl. G06F 11/14; G06F 13/38; H04L 67/1097

(52) U.S. Cl. CPC G06F 11/1407; G06F 13/38; H04L 67/1097

(57) ABSTRACT

A method, computer program product, and computing system for detecting a request, by a network-coupled processing device, to process a training dataset stored within a network-coupled storage device for training an artificial intelligence (AI) model. The training dataset is processed using the network-coupled processing device by storing a plurality of checkpoints generated during the training of the AI model within multi-tiered storage of the network-coupled storage device. A checkpoint relevance metric is determined for each checkpoint of the plurality of checkpoints. A checkpoint is migrated from one performance tier within the multi-tiered storage of the network-coupled storage device to another performance tier based upon, at least in part, the checkpoint relevance metric for the checkpoint.

### BACKGROUND

Over the past decade, artificial intelligence (AI) technologies have advanced substantially and are now widely used in almost every industry. In particular, Generative AI (GenAI) has enabled the everyday use of AI to perform common tasks without need for deep technical skill. Large Language Models (LLMs) are able to summarize complex documents, generate novel content, and translate between multiple languages. The newest reasoning models are able to perform complex tasks by dynamically making plans, taking actions, and forming observations that gradually work towards the desired outcome. Large Multimodal Models (LMMs) provide similar summarization, translation, and generation capabilities for image, video, audio, and other types of non-text data.

The key innovation behind GenAI is the training of foundation models with billions to trillions of learnable parameters (i.e., weights) from extremely large training data sets (hundreds of terabytes) using self-supervised techniques that do not require human labeling of individual training examples. Large scale training datasets may consist of many files or objects each containing a unique portion of training data created by cleaning and transforming raw data collected from web pages, internet discussion forums, public domain books, etc. The files or objects within a training dataset may be organized in a number of ways, ranging from a single flat directory (or object prefix) to a hierarchy of directories (or object prefixes). Each file or object may be an individual unstructured training example, such as an image or a collection of training examples, pre-processed into a vectorized form and stored in a structured format.

Training an artificial intelligence (AI) model (e.g., a foundation LLM) can be a large computational task. For example, training one 70 billion parameter LLM required twenty-four days of processing by 128 Graphics Processing Units (GPUs) housed in sixteen high performance servers. Leading edge models with hundreds of billions or trillions of parameters can require tens of thousands of GPUs and months of runtime to train. For large foundation models, the amount of memory required to store model parameters and additional information (e.g., optimizer state) exceeds the capacity of a single GPU. Therefore, model parallelization techniques are often used to split a single model instance across multiple GPUs. Depending on the technique, this can require a large amount of GPU-to-GPU communication to propagate calculations at model split boundaries.

### SUMMARY OF DISCLOSURE

### Migrating Checkpoint Data with Multi-Tier Data Storage

In one example implementation, a computer-implemented method executed on a computing device may include, but is not limited to, detecting a request, by a network-coupled processing device, to process a training dataset stored within a network-coupled storage device for training an artificial intelligence (AI) model. The training dataset is processed using the network-coupled processing device by storing a plurality of checkpoints generated during the training of the AI model within multi-tiered storage of the network-coupled storage device. A checkpoint relevance metric is determined for each checkpoint of the plurality of checkpoints. A checkpoint is migrated from one performance tier within the multi-tiered storage of the network-coupled storage device to another performance tier based upon, at least in part, the checkpoint relevance metric for the checkpoint.

One or more of the following example features may be included. The training dataset may be processed by a plurality of network-coupled processing devices. Each network-coupled processing device may interface with the network-coupled storage device using a separate storage controller. Each network-coupled processing device may be a Graphical Processing Unit (GPU). Migrating the checkpoint from one performance tier within the multi-tiered storage of the network-coupled storage device to another performance tier may include processing a request to migrate the checkpoint from a lower performance tier to a higher performance tier of the multi-tiered storage of the network-coupled storage device. Determining the checkpoint relevance metric for each checkpoint of the plurality of checkpoints may include monitoring demand associated with the checkpoint over a defined period of time. The multi-tiered storage of the network-coupled storage device may include a dynamic random-access memory (DRAM) storage tier, a solid-state storage tier, and a hard drive storage tier.

In another example implementation, a computer program product resides on a computer readable medium that has a plurality of instructions stored on it. When executed by a processor, the instructions cause the processor to perform operations that may include, but are not limited to, detecting a request, by a network-coupled processing device, to process a training dataset stored within a network-coupled storage device for training an artificial intelligence (AI) model. The training dataset is processed using the network-coupled processing device by storing a plurality of checkpoints generated during the training of the AI model within multi-tiered storage of the network-coupled storage device. A checkpoint relevance metric is determined for each checkpoint of the plurality of checkpoints. A checkpoint is migrated from one performance tier within the multi-tiered storage of the network-coupled storage device to another performance tier based upon, at least in part, the checkpoint relevance metric for the checkpoint.

One or more of the following example features may be included. The training dataset may be processed by a plurality of network-coupled processing devices. Each network-coupled processing device may interface with the network-coupled storage device using a separate storage controller. Each network-coupled processing device may be a Graphical Processing Unit (GPU). Migrating the checkpoint from one performance tier within the multi-tiered storage of the network-coupled storage device to another performance tier may include processing a request to migrate the checkpoint from a lower performance tier to a higher performance tier of the multi-tiered storage of the network-coupled storage device. Determining the checkpoint relevance metric for each checkpoint of the plurality of checkpoints may include monitoring demand associated with the checkpoint over a defined period of time. The multi-tiered storage of the network-coupled storage device may include a dynamic random-access memory (DRAM) storage tier, a solid-state storage tier, and a hard drive storage tier.

In another example implementation, a computing system includes at least one processor and at least one memory architecture coupled with the at least one processor, wherein the at least one processor is configured to detect a request, by a network-coupled processing device, to process a training dataset stored within a network-coupled storage device for training an artificial intelligence (AI) model. The training dataset is processed using the network-coupled processing device by storing a plurality of checkpoints generated during the training of the AI model within multi-tiered storage of the network-coupled storage device. A checkpoint relevance metric is determined for each checkpoint of the plurality of checkpoints. A checkpoint is migrated from one performance tier within the multi-tiered storage of the network-coupled storage device to another performance tier based upon, at least in part, the checkpoint relevance metric for the checkpoint.

One or more of the following example features may be included. The training dataset may be processed by a plurality of network-coupled processing devices. Each network-coupled processing device may interface with the network-coupled storage device using a separate storage controller. Each network-coupled processing device may be a Graphical Processing Unit (GPU). Migrating the checkpoint from one performance tier within the multi-tiered storage of the network-coupled storage device to another performance tier may include processing a request to migrate the checkpoint from a lower performance tier to a higher performance tier of the multi-tiered storage of the network-coupled storage device. Determining the checkpoint relevance metric for each checkpoint of the plurality of checkpoints may include monitoring demand associated with the checkpoint over a defined period of time. The multi-tiered storage of the network-coupled storage device may include a dynamic random-access memory (DRAM) storage tier, a solid-state storage tier, and a hard drive storage tier.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system, and a storage optimization process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the storage optimization process of FIG. 1 according to one or more example implementations of the disclosure for temporarily disabling cache consistency;

FIGS. 4-6 are example diagrammatic views of the storage optimization process of FIG. 1 according to one or more example implementations of the disclosure for temporarily disabling cache consistency;

FIG. 7 is an example flowchart of the storage optimization process of FIG. 1 according to one or more example implementations of the disclosure for temporarily adjusting Service Level Agreements;

FIGS. 8-9 are example diagrammatic views of the storage optimization process of FIG. 1 according to one or more example implementations of the disclosure for temporarily adjusting Service Level Agreements;

FIG. 10 is an example flowchart of the storage optimization process of FIG. 1 according to one or more example implementations of the disclosure for pre-allocating storage capacity for checkpoint data;

FIGS. 11-12 are example diagrammatic views of the storage optimization process of FIG. 1 according to one or more example implementations of the disclosure for pre-allocating storage capacity for checkpoint data;

FIG. 13 is an example flowchart of the storage optimization process of FIG. 1 according to one or more example implementations of the disclosure for temporarily reducing data protection for checkpoint data;

FIGS. 14-15 are example diagrammatic views of the storage optimization process of FIG. 1 according to one or more example implementations of the disclosure for temporarily reducing data protection for checkpoint data;

FIG. 16 is an example flowchart of the storage optimization process of FIG. 1 according to one or more example implementations of the disclosure for migrating checkpoint data with multi-tier data storage; and

FIGS. 17-18 are example diagrammatic views of the storage optimization process of FIG. 1 according to one or more example implementations of the disclosure for migrating checkpoint data with multi-tier data storage.

Like reference symbols in the various drawings indicate like elements.

### DETAILED DESCRIPTION

### System Overview

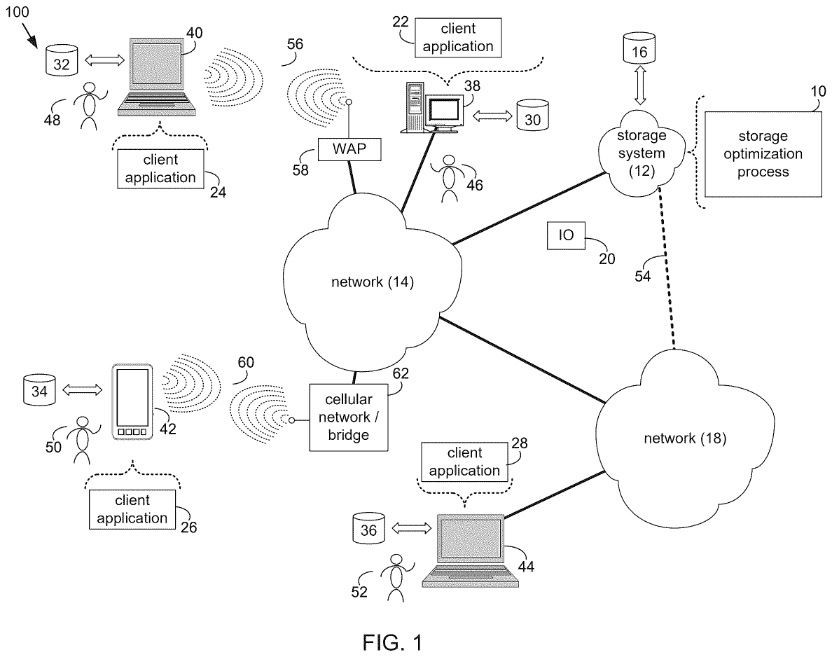

Referring to FIG. 1, there is shown storage optimization process 10 that may reside on and may be executed by storage system 12, which may be connected to network 14 (e.g., the Internet or a local area network). Examples of storage system 12 may include but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of storage optimization process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of storage optimization process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

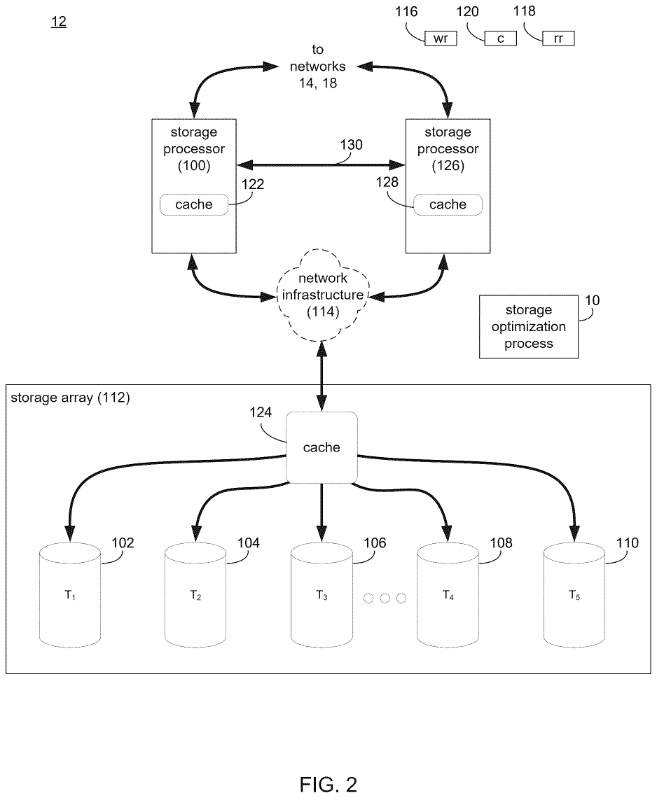

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of storage optimization process 10. The instruction sets and subroutines of storage optimization process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of storage optimization process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of storage optimization process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of storage optimization process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of storage optimization process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of storage optimization process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### Artificial Intelligence (AI) Model Training and Checkpointing

As discussed above, training an artificial intelligence (AI) model (e.g., a foundation LLM) can be a large computational task. For example, training one 70 billion parameter LLM required 24 days of processing by 128 Graphics Processing Units (GPUs) housed in 16 high performance servers. Leading edge models with hundreds of billions or trillions of parameters can require tens of thousands of GPUs and months of runtime to train. For large foundation models, the amount of memory required to store model parameters and additional information (e.g., optimizer state) exceeds the capacity of a single GPU. Therefore, model parallelization techniques are often used to split a single model instance across multiple GPUs. Depending on the technique, this can require a large amount of GPU-to-GPU communication to propagate calculations at model split boundaries.

The typical AI model training process consists of:
Reading a batch of training examples from a training dataset stored on persistent file or object storage;
Inputting the training examples into the model using the current learned weights to generate predictions (i.e., a forward pass);
Comparing the predictions to the correct ground truth answers to calculate a numerical “loss” score representing how well the model performs;
Updating the model weights using the loss score to improve the likelihood of correct predictions in the future (backward pass); and
Periodically evaluating model accuracy against a validation dataset to monitor improvement.

This process is repeated until a stable model with acceptable accuracy is achieved or a predefined number of training examples are consumed. After processing a predefined number of batches, the training process is interrupted to save the current model weights and other training state to persistent file or object storage as a checkpoint that can be used to resume training after a planned or unplanned interruption to training. While a checkpoint is saved, model training is typically paused, leaving GPU resources idle and underutilized. Checkpoints may be saved in a variety of file or object formats; however all are generally optimized to be sequentially written by a single writer. When data parallelism is used, only a single AI model instance is checkpointed to persistent storage. When model parallelism is used, the checkpoint data for each piece of the split AI model is typically saved to a separate file to maintain the single sequential writer performance optimization. Quickly checkpointing large AI models can require a substantial amount of write bandwidth to persistent to storage. For example, checkpointing a 530 billion parameter LLM every hour while minimizing GPU idle time to 5% requires writing 7.4 terabytes (TB) of data to be saved in 180 seconds for a sustained storage write bandwidth of approximately 41 gigabytes-per-second (GBps).

Training, or post-training large AI models presents three key challenges for storage systems supporting large GPU clusters: 1) reading training data with sufficient throughput and latency to keep a large number GPU's spread across many servers maximally utilized during training; 2) writing checkpoint data from multiple GPUs and servers with sufficient speed to minimize training pauses and GPU idleness; and 3) efficiently managing the storage capacity consumed by large AI model checkpoints.

All of these challenges become more significant while providing storage for large GPU clusters that host the simultaneous training of multiple AI models. Existing storage solutions to address the AI training and checkpointing challenges generally fall into two categories: 1) the use of high-performance scale-out storage; and 2) staging data on local GPU server storage.

High performance scale out storage solutions, like parallel file systems, are able to achieve significant levels of performance. Especially those designed for use in extremely large high-performance computing (HPC) clusters for scientific workloads. While such storage systems can be used for AI model training, they have certain disadvantages. For example, many AI training workloads do not require the levels of performance provided by HPC class storage. Also, HPC class storage is designed to solve a broader range of problems, such as sustaining high write performance when single files/objects are written to by multiple random writers. As these capabilities are not needed for AI, such storage systems exceed the requirements of AI model training workloads which may lead to unnecessary costs. Additionally, high-performance storage market's niche requirements allows vendors to charge a price premium. This may further lead to excessive spending when buying storage for AI model training. Finally, installing and maintaining parallel filesystems requires substantial expertise due to their complexity.

Another solution is to stage training and checkpoint data on the solid-state drives in each GPU server. This involves copying training data from long-term network attached file/object storage to the local storage within each GPU that will participate in training the AI model. This copying typically must be completed before AI model training can be started and must be explicitly deleted after training is finished. When using model parallel training across GPUs in multiple servers, each GPU stores its checkpoint data on its server's local storage. At some time after the checkpoint completes, the checkpoint data is copied to network attached file/object storage to provide long-term protection and enables using the checkpoint to resume model training on potentially different GPU servers.

Staging training and data checkpoint data in this way has the following disadvantages: complexity, risk, inefficiency, and cost. For example, staging training and checkpoint data on local server storage introduces non-trivial data management challenges, especially for large scale AI clusters. Manually orchestrating and managing such data copying is unrealistic at scale. Automating the data copying can require significant development as it may require integrating with a scheduler used to orchestrate AI jobs in large GPU clusters.

Storing checkpoint data on local GPU storage introduces a risk of data loss if the server fails before the checkpoint data is written to reliable network attached storage. Checkpoint data becomes increasingly valuable as training progresses given the high accumulated cost required to produce it. Loss of a checkpoint may require repeating prior training.

Duplicating training data on multiple GPU training servers is inefficient as each GPU may only require a subset of the training data for data parallel training. The network bandwidth and local storage capacity used to transfer and store this unneeded data are wasted. Finally, relying on GPU local storage may increase the amount of storage capacity required in each GPU, thus increasing its cost. The aggregate cost scales with the number of GPU and is likely more expensive than using a shared storage solution.

### The Storage Optimization Process

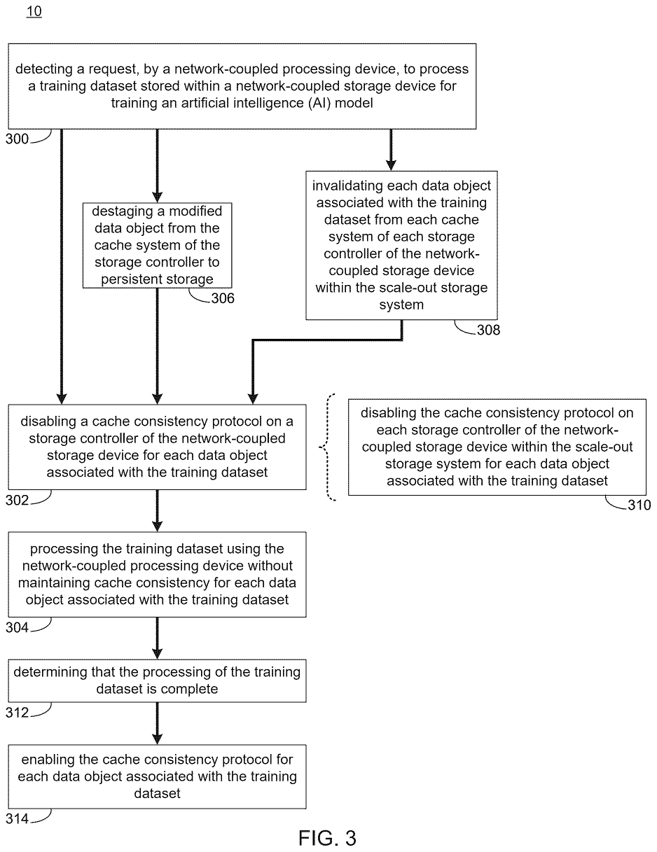

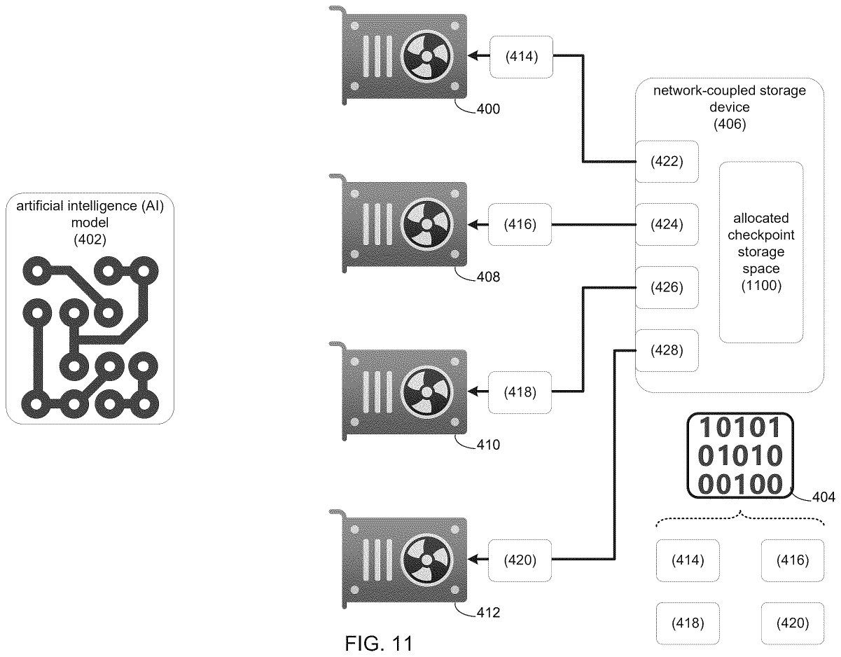

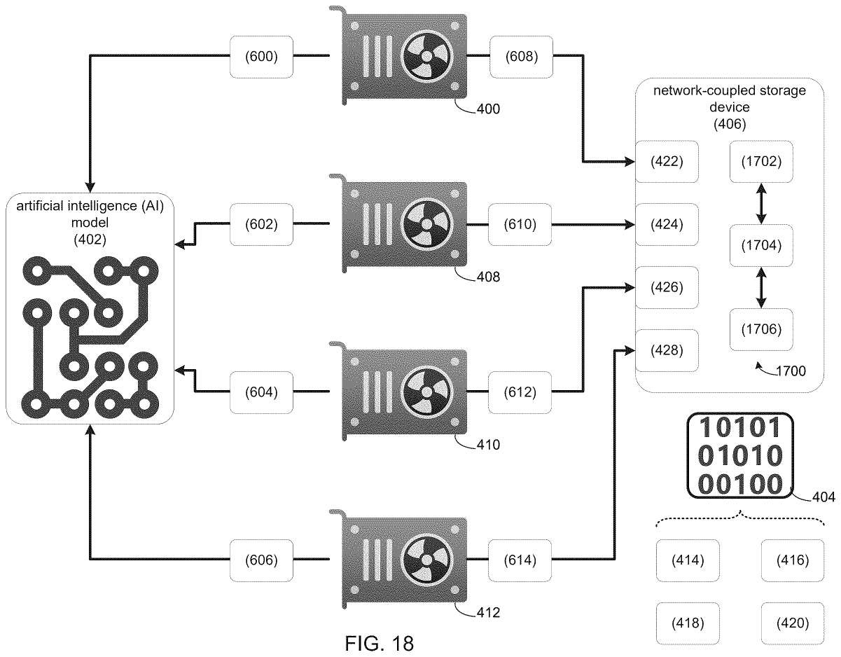

Referring also to FIGS. 3-18 and in some implementations, storage optimization process 10 provides various approaches to enhance the training of AI models using various network-coupled processing devices (e.g., GPUs) connected to a network-coupled storage device of a scale-out storage system. For example, storage optimization process 10 allows a network-coupled storage device to detect the training of an AI model and to regulate particular aspects of the training dataset (e.g., cache consistency, Service Level Agreements (SLAs), pre-allocation of storage space for checkpoint data, data protection levels, and checkpoint data migration). In this manner, storage optimization process 10 improves the processing of training data by network-coupled processing devices without staging training data to each network-coupled processing device.

### Temporarily Disabling Cache Consistency

Referring also to FIGS. 3-6 and in some implementations, storage optimization process 10 detects 300 a request, by a network-coupled processing device, to process a training dataset stored within a network-coupled storage device for training an artificial intelligence (AI) model. A cache consistency protocol is disabled 302 on a storage controller of the network-coupled storage device for each data object associated with the training dataset. The training dataset is processed 304 using the network-coupled processing device without maintaining cache consistency for each data object associated with the training dataset.

Storage systems typically use caches to improve IO latency and bandwidth. For read IO requests, this may take the form of temporarily storing data likely to be read on high-speed storage media to reduce latency and maximize bandwidth. For write IO requests, this may include temporarily storing write data on high-speed media to reduce latency. In some implementations, caches are present in the “scale-out” storage systems used in GPU clusters. However, scale out storage systems have an additional challenge maintaining cache consistency across storage controller nodes. In such storage systems, data read through one storage controller may be written and modified via another storage controller. In this case, any read data cached in the first storage controller needs to be invalidated or updated when the second storage controller receives the modified data. Otherwise, the first storage controller is in danger of responding to future read requests with invalid data using the out of date cached copy. Maintaining cache consistency in a scale-out storage system requires complex network communication protocols and advanced techniques like distributed locking. The computational overhead of such cache consistency protocols can limit storage performance, especially for heavily shared data. As will be discussed in greater detail below, storage optimization process 10 disables cache consistency for a training dataset by leveraging the fact that the training dataset will remain unchanged throughout the duration of the training job. Accordingly, storage optimization process 10 avoids cache consistency costs across storage controllers as there is no need to maintain cache consistency to protect against data updates.

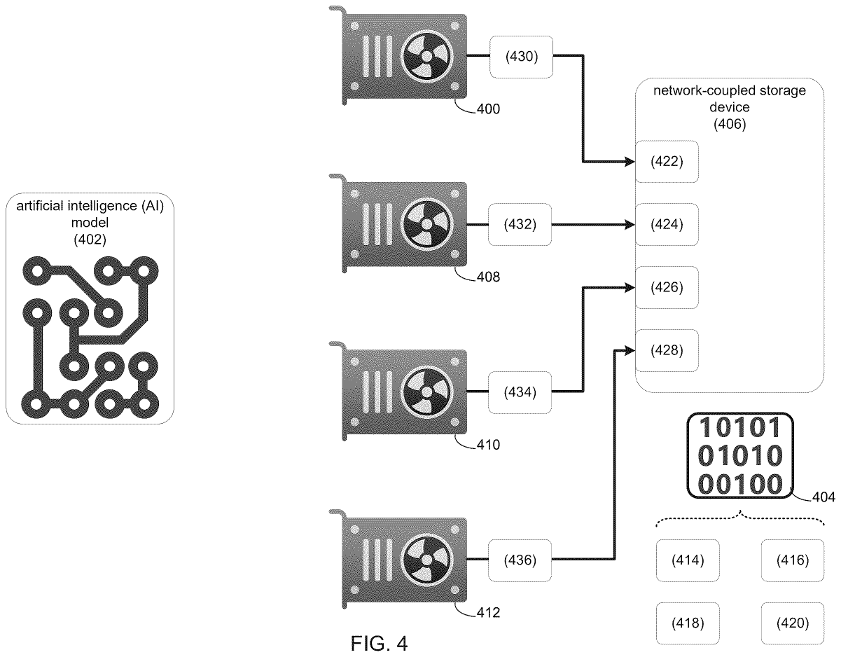

In some implementations, storage optimization process 10 detects 300 a request, by a network-coupled processing device, to process a training dataset stored within a network-coupled storage device for training an artificial intelligence (AI) model. Referring also to FIG. 4 and in some implementations, a network-coupled processing device (e.g., network-coupled processing device 400) is used to train an artificial intelligence (AI) model (e.g., AI model 402) using a training dataset (e.g., training dataset 404) stored on a network-coupled storage device (e.g., network-coupled storage device 406).

In some implementations, the network-coupled processing device is a computing device that is communicatively coupled (e.g., via a network) to network-coupled storage device 406 and is configured to access training dataset 404 stored on network-coupled storage device 406. In some implementations, network-coupled processing device 400 is a Graphical Processing Unit (GPU). For example, GPUs are often used for training AI models due to their exceptional ability to handle the large-scale parallel processing required for deep learning tasks. GPUs are designed to perform numerous calculations simultaneously, making them ideal for the matrix and vector operations common in AI model training. This parallelism allows for faster computation compared to Central Processing Units (CPUs), which are optimized for sequential processing. Additionally, the architecture of GPUs enables them to process a large number of operations per second, crucial for managing the vast amounts of data involved in training complex AI models. They efficiently handle large datasets due to their high memory bandwidth and ability to perform multiple operations concurrently.

In some implementations, the training dataset is processed by a plurality of network-coupled processing devices. For example, when training AI model 402, storage optimization process 10 may use a cluster of network-coupled processing devices (e.g., network-coupled processing devices 400, 408, 410, 412) to train AI model 402 using training dataset 404 from network-coupled storage device 406. As will be discussed in greater detail below, each network-coupled processing device may be assigned to process a separate portion of training dataset 404. In one example, portion 414 may be assigned to network-coupled processing device 400; portion 416 may be assigned to network-coupled processing device 408; portion 418 may be assigned to network-coupled processing device 410; and portion 420 may be assigned to network-coupled processing device 412.

In some implementations, each network-coupled processing device interfaces with the network-coupled storage device using a separate storage controller. For example, network-coupled storage device 406 may define all of, or a portion of, a storage system as described above in FIG. 2 (e.g., storage system 12). As shown in the example of FIG. 4, network-coupled storage device 406 includes a plurality of storage controllers (e.g., storage controllers 422, 424, 426, 428). In some implementations, a storage controller is a hardware and/or software component that manages the processing of data into and out of network-coupled processing device. For example, storage controllers 422, 424, 426, 428 may include the same structure and functionality as storage processors 100, 126 as described above and as shown in FIG. 2. In some implementations, storage optimization process 10 assigns a separate storage controller to each network-coupled processing device. In the example of FIG. 4, storage optimization process 10 assigns storage controller 422 for interfacing with network-coupled processing device 400; storage controller 424 for interfacing with network-coupled processing device 408; storage controller 426 for interfacing with network-coupled processing device 410; and storage controller 428 for interfacing with network-coupled processing device 412. In some implementations, each storage controller includes a separate cache system for caching data with the structure and/or functionality as described above for cache 122, 128 for storage processors 100, 126.

In some implementations and as shown in FIG. 4, storage optimization process 10 detects 300 a request, by a network-coupled processing device (e.g., network-coupled processing devices 400, 408, 410, 412), to process training dataset 404 for training an artificial intelligence (AI) model. In one example, storage optimization process 10 processes the request using a scheduler that initiates an application programming interface (API) to notify network-coupled storage device 406 that the data under a specific filesystem directory contains the target training dataset. In the example of FIG. 4, network-coupled processing devices 400, 408, 410, 412 are shown providing requests (e.g., requests 430, 432, 434, 436) for access to training dataset 404 of network-coupled storage device 406. It will be appreciated that network-coupled storage device 406 may receive a request from any number of network-coupled processing devices and/or other devices within a cluster of network-coupled processing devices to detect 300 the request to process training dataset 404 within the scope of the present disclosure.

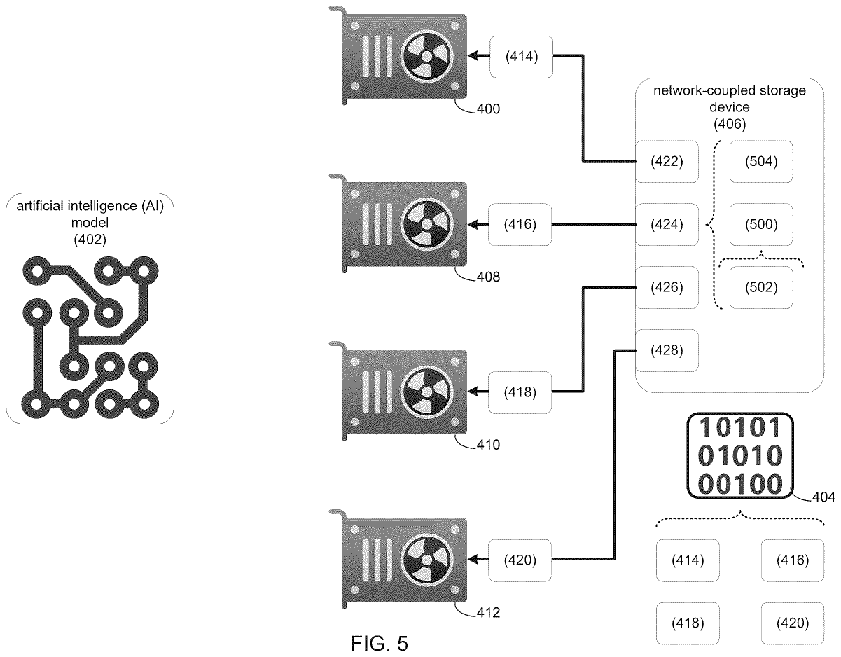

Referring also to FIG. 5 and as discussed above, each network-coupled storage device may include a plurality of storage controllers (e.g., storage controllers 422, 424, 426, 428), each with a cache memory system (e.g., cache memory system 500 for storage controller 424) configured to store cached versions of training dataset 404 from network-coupled storage device 406. As discussed above in a scale-out storage system, maintaining cache consistency across storage controllers is a significant issue. For example, data read through one storage controller may be written and modified via another storage controller. In this case, any read data cached in the first storage controller needs to be invalidated or updated when the second storage controller receives the modified data. However, this cache consistency is not needed as the training dataset is not updated or modified during training of AI model 402.

In response to detecting 300 the request to process training dataset 404 within network-coupled storage device 406 for training the AI model, storage optimization process 10 determines a cache state for each data object associated with training dataset 404 within cache memory system 500 of storage controller 424. For example, before disabling a cache consistency protocol on a storage controller of the network-coupled storage device, storage optimization process 10 destages 306 a modified data object from the cache system of the storage controller to persistent storage. For example, storage optimization process 10 prepares storage controller 424 of network-coupled storage device 406 for processing AI model training dataset 404 by destaging (e.g., moves or copies) modified data (e.g., modified data 502) residing in a cache memory system 500 of storage controller 424 to persistent storage. In one example, persistent storage includes storage targets as described above. Accordingly, by destaging 306 modified data objects (e.g., data objects that may or may not be associated with training dataset 404) to persistent storage within network-coupled storage device 406, storage optimization process 10 readies storage controller 424 for processing portions of training dataset 404 by a particular network-coupled processing device.

In some implementations, storage optimization process 10 invalidates 308 each data object associated with the training dataset from each cache system of each storage controller of the network-coupled storage device within the scale-out storage system. For example, storage optimization process 10 forces each storage controller to invalidate any cached data objects or portions associated with training dataset 404.

In some implementations, storage optimization process 10 disables 302 a cache consistency protocol on the storage controller of the network-coupled storage device for each data object associated with the training dataset. For example, a cache consistency protocol is a set of constraints used to maintain consistency among multiple cache copies of data in a distributed system (e.g., scale-out storage system). In storage systems where data is cached in multiple locations, storage optimization process 10 ensures that all copies of the data reflect the most recent updates. Cache consistency protocols (e.g., cache consistency protocol 504) coordinate updates and invalidations across cache memory systems of separate storage controllers.

In some implementations, disabling 302 the cache consistency protocol on the network-coupled storage device for each data object associated with the training dataset includes disabling 310 the cache consistency protocol on each storage controller of the network-coupled storage device within the scale-out storage system for each data object associated with the training dataset. For example, with a plurality of storage controllers (e.g., storage controllers 422, 424, 426, 428) each having their own cache memory with cache consistency protocols across the scale-out storage system, storage optimization process 10 disables 310 the cache consistency protocol of each storage controller (e.g., storage controllers 422, 424, 426, 428) such that no data objects or portions of training dataset 404 are cached in storage controllers 422, 424, 426, 428 of network-coupled storage device 406.

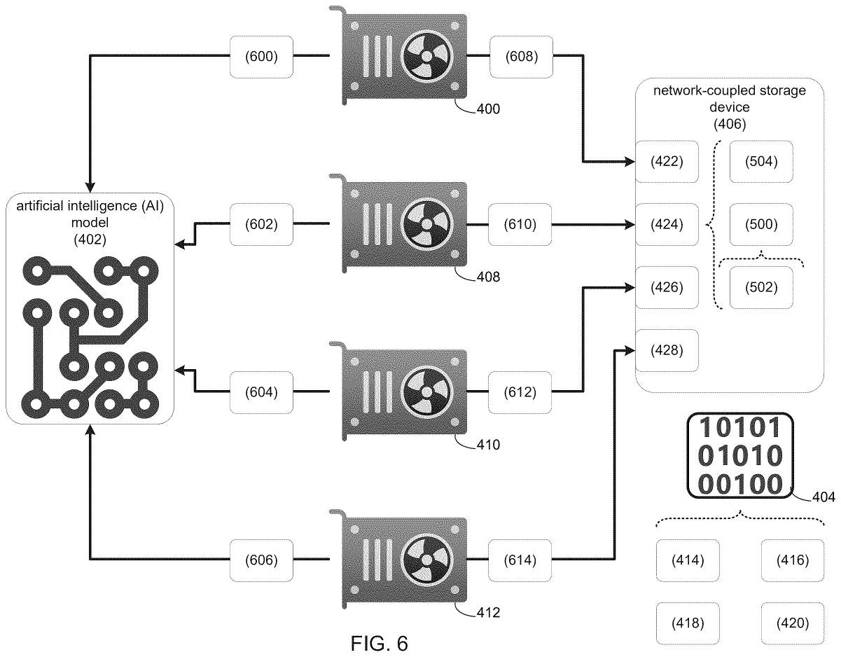

In some implementations, storage optimization process 10 processes 304 the training dataset using the network-coupled processing device without maintaining cache consistency for each data object associated with the training dataset. Referring also to FIG. 6, storage optimization process 10 processes portion 414 of training dataset 404 using network-coupled processing device 400 to update AI model 402 (shown in FIG. 6 as update 600 to AI model 402); portion 416 of training dataset 404 using network-coupled processing device 408 to update AI model 402 (shown in FIG. 6 as update 602 to AI model 402); portion 418 of training dataset 404 using network-coupled processing device 410 to update AI model 402 (shown in FIG. 6 as update 604 to AI model 402); and portion 420 of training dataset 404 using network-coupled processing device 412 to update AI model 402 (shown in FIG. 6 as update 606 to AI model 402). In some implementations, while storage optimization process 10 processes 304 training dataset 404 without maintaining cache consistency for the training data, each storage controller caches each portion of training data processed by the respective network-coupled processing device. In this manner, each portion of training data processed by a network-coupled processing device is cached but without maintaining cache consistency across the plurality of storage controllers.

As will be discussed in greater detail below, processing 304 training dataset 404 using network-coupled processing devices 400, 408, 410, 412 includes processing checkpoints (e.g., checkpoints 608, 610, 612, 614) generated for storage in network-coupled storage device 406. In this example, storage optimization process 10 processes checkpoints on storage controllers 422, 424, 426, 428 without maintaining cache consistency for each checkpoint. As discussed above, storage optimization process 10 uses checkpoints to recover AI model training during any interruption of the training of AI model 402. In some implementations, when data parallelism is used (i.e., which involves sending different portions of the training data to different network-coupled processing devices), only a single AI model instance is checkpointed to persistent storage (e.g., one of checkpoints 608, 610, 612, 614). When model parallelism is used (i.e., where a single instance of the AI model is spread across multiple network-coupled processing devices) each network-coupled processing device will persist the checkpoint for it's portion of the AI model (e.g., each of checkpoints 608, 610, 612, 614). Accordingly, processing 304 training dataset 404 using network-coupled processing devices 400, 408, 410, 412 includes processing checkpoints (e.g., checkpoints 608, 610, 612, 614) generated for storage in network-coupled storage device 406 where the number of checkpoints depends upon the type of parallelism used by the plurality of network-coupled processing devices.

In some implementations, storage optimization process 10 determines 312 that the processing of the training dataset is complete and enables 314 the cache consistency protocol for each data object associated with the training dataset. For example, in response to completing the processing of each portion (e.g., portions 414, 416, 418, 420) of training dataset 404 from network-coupled storage device 406, network-coupled processing devices 400, 408, 410, 412 may provide a message (e.g., using an API) to network-coupled storage device 406 indicating that the processing of training dataset 404 is complete. In another example, network-coupled storage device 406 monitors the processing of training dataset 404 by network-coupled processing devices 400, 408, 410, 412 to determine 312 that the processing of training dataset 404 is complete. In response to determining 312 that training dataset 404 is complete, storage optimization process 10 enables 314 the previously disabled cache consistency protocol for each data object associated with training dataset 404. For example, storage optimization process 10 may enable 314 cache consistency protocol 504 on cache memory system 500 of storage controller 424 in response to determining 314 that the processing of training dataset 404 is complete. In this manner, storage optimization process 10 returns network-coupled storage device 406 and its storage controllers to their previously defined cache consistency protocols.

### Temporarily Adjusting Service Level Agreements (SLAS)

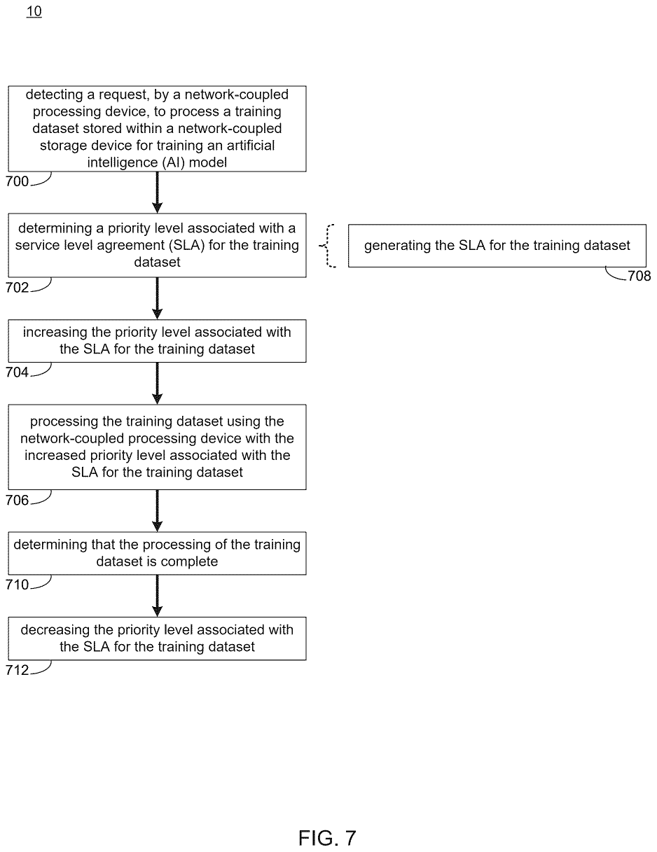

Referring also to FIGS. 7-9 and in some implementations, storage optimization process 10 detects 700 a request, by a network-coupled processing device, to process a training dataset stored within a network-coupled storage device for training an artificial intelligence (AI) model. A priority level associated with a service level agreement (SLA) for the training dataset is determined 702. The priority level associated with the SLA for the training dataset is increased 704. The training dataset is processed 706 using the network-coupled processing device with the increased priority level associated with the SLA for the training dataset.

In some implementations, storage optimization process 10 detects 700 a request, by a network-coupled processing device, to process a training dataset stored within a network-coupled storage device for training an artificial intelligence (AI) model. As discussed above, a network-coupled processing device (e.g., network-coupled processing device 400) is used to train an artificial intelligence (AI) model (e.g., AI model 402) using a training dataset (e.g., training dataset 404) stored on a network-coupled storage device (e.g., network-coupled storage device 406).

In some implementations, the network-coupled processing device is a computing device that is communicatively coupled (e.g., via a network) to network-coupled storage device 406 and is configured to access training dataset 404 stored on network-coupled storage device 406. In some implementations, network-coupled processing device 400 is a Graphical Processing Unit (GPU).

In some implementations, the training dataset is processed by a plurality of network-coupled processing devices. For example, when training AI model 402, storage optimization process 10 may use a cluster of network-coupled processing devices (e.g., network-coupled processing devices 400, 408, 410, 412) to train AI model 402 using training dataset 404 from network-coupled storage device 406. As will be discussed in greater detail below, each network-coupled processing device may be assigned to process a separate portion of training dataset 404. In one example, portion 414 may be assigned to network-coupled processing device 400; portion 416 may be assigned to network-coupled processing device 408; portion 418 may be assigned to network-coupled processing device 410; and portion 420 may be assigned to network-coupled processing device 412.

In some implementations, each network-coupled processing device interfaces with the network-coupled storage device using a separate storage controller. For example, network-coupled storage device 406 may define all of, or a portion of, a storage system as described above in FIG. 2 (e.g., storage system 12). As shown in the example of FIG. 4, network-coupled storage device 406 includes a plurality of storage controllers (e.g., storage controllers 422, 424, 426, 428). In some implementations, a storage controller is a hardware and/or software component that manages the processing of data into and out of network-coupled processing device. For example, storage controllers 422, 424, 426, 428 may include the same structure and functionality as storage processors 100, 126 as described above and as shown in FIG. 2. In some implementations, storage optimization process 10 assigns a separate storage controller to each network-coupled processing device. In the example of FIG. 4, storage optimization process 10 assigns storage controller 422 for interfacing with network-coupled processing device 400; storage controller 424 for interfacing with network-coupled processing device 408; storage controller 426 for interfacing with network-coupled processing device 410; and storage controller 428 for interfacing with network-coupled processing device 412. In some implementations, each storage controller includes a separate cache system for caching data with the structure and/or functionality as described above for cache 122, 128 for storage processors 100, 126.

In some implementations and as shown in FIG. 4, storage optimization process 10 detects 700 a request, by a network-coupled processing device (e.g., network-coupled processing devices 400, 408, 410, 412), to process training dataset 404 for training an artificial intelligence (AI) model. In one example, storage optimization process 10 processes the request using a scheduler that initiates an application programming interface (API) to notify network-coupled storage device 406 that the data under a specific filesystem directory contains the target training dataset. In the example of FIG. 4, network-coupled processing devices 400, 408, 410, 412 are shown providing requests (e.g., requests 430, 432, 434, 436) to process training dataset 404 of network-coupled storage device 406. It will be appreciated that network-coupled storage device 406 may receive a request from any number of network-coupled processing devices and/or other devices within a cluster of network-coupled processing devices to detect 700 the request to process training dataset 404 for training the AI model within the scope of the present disclosure.

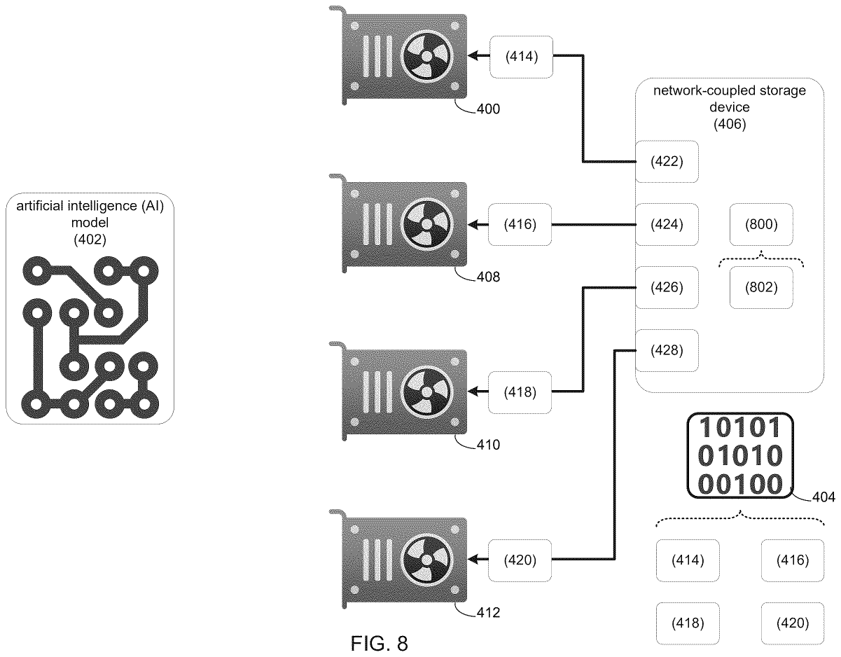

In some implementations and referring also to FIG. 8, storage optimization process 10 determines 702 a priority level associated with a service level agreement (SLA) (e.g., SLA 800) for the training dataset. For example, storage systems (e.g., network-coupled storage device 406) that are capable of hosting multiple workloads often provide a way to specify and enforce Service Level Agreements (SLAs) for each workload to ensure a minimum amount of performance, reliability, availability, etc. When a storage system is unable to meet all of its SLAs, workload priorities are often used to determine which SLAs to honor and which to violate. In some implementations, SLAs include a priority level that defines how data objects are prioritized based on various factors to ensure that network-coupled storage device 406 meets the performance and availability requirements specified by different clients or applications. One common approach is tiered storage, where data is stored on different types of storage media according to SLA requirements. High-priority data with stringent performance and availability needs might be stored on faster, more reliable media, while lower-priority data might be stored on slower, less expensive media. In another example, Quality of Service (QoS) policies are implemented to allocate resources such as bandwidth and IOPS (Input/Output Operations Per Second) according to the priority of the SLA, ensuring higher-priority SLAs receive more resources to meet their performance requirements. For SLAs requiring high availability, redundancy and replication techniques, such as RAID configurations or geographic replication, are used to ensure data remains accessible even in the event of a failure. Continuous monitoring of network-coupled storage device 406 helps ensure SLA requirements are met, with alerts set up to notify administrators of potential issues affecting SLA compliance, allowing for proactive management. Additionally, dynamic resource allocation can adjust the distribution of storage resources in real-time based on the current demands and priorities of different SLAs. Referring again to FIG. 8, storage optimization process 10 determines 702 a priority level (e.g., priority level 802) for SLA 800 for training dataset 404 by identifying priority level 802 from SLA 800 defined within network-coupled storage device 406 for training dataset 404.

In some implementations, determining 702 the priority level associated with the SLA for the training dataset includes generating 708 the SLA for the training dataset. For example, SLA 800 may be generated with input from service providers (i.e., the provider of network-coupled storage device 406) and clients, by defining the expected level of service and performance metrics of network-coupled storage device 406 for a particular client's data. In one example, training dataset 404 may include a default SLA for data stored in network-coupled storage device 406. In this example, storage optimization process 10 generates 708 an SLA with a default priority level when training dataset 404 is initially stored in network-coupled storage device 406.

In some implementations, storage optimization process 10 increases 704 the priority level associated with the SLA for the training dataset. For example, storage optimization process 10 defines SLAs for individual training datasets, as opposed to SLAs for whole network-coupled storage devices or network-coupled processing devices and enables the priority of such SLAs to be increased for the duration of an AI model training process. Referring again to FIG. 8 and in one example, storage optimization process 10 increases 704 priority level 802 associated with SLA 800 for training dataset 404 by increasing priority level 802 to a maximum priority level. In another example, storage optimization process 10 increases 704 priority level 802 associated with SLA 800 for training dataset 404 by increasing priority level 802 by a predefined number of priority levels or values. In this example, storage optimization process 10 may retain a maximum priority level for other urgent data processing. With an SLA having an increased priority level, storage optimization process 10 allocates more network-coupled storage device resources to maximize the read performance of network-coupled processing devices reading portions (e.g., portions 414, 416, 418, 420) of training dataset 404 from network-coupled storage device 406.

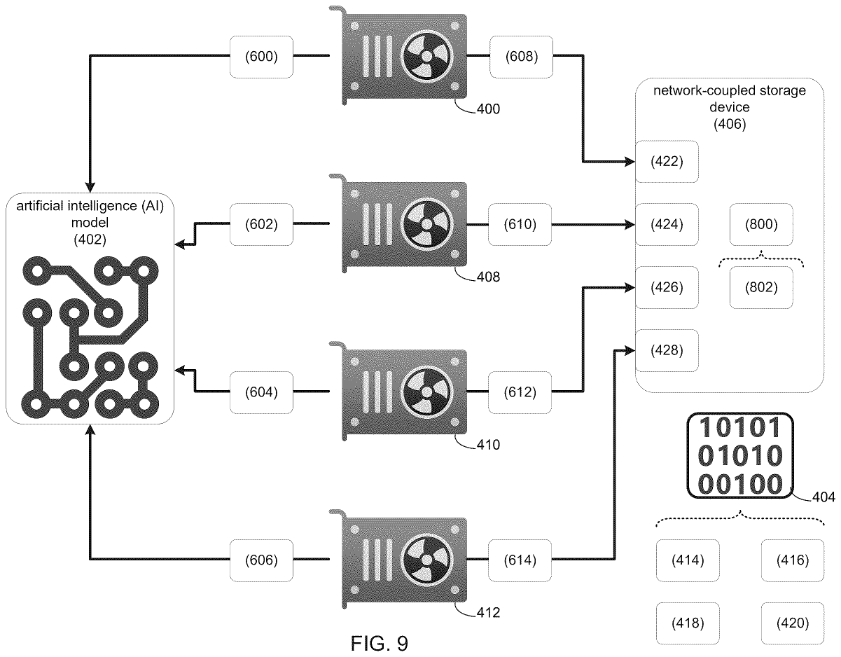

In some implementations, storage optimization process 10 processes 706 the training dataset using the network-coupled processing device with the increased priority level associated with the SLA for the training dataset. Referring also to FIG. 9, storage optimization process 10 processes portion 414 of training dataset 404 using network-coupled processing device 400 to update AI model 402 (shown in FIG. 9 as update 600 to AI model 402); portion 416 of training dataset 404 using network-coupled processing device 408 to update AI model 402 (shown in FIG. 9 as update 602 to AI model 402); portion 418 of training dataset 404 using network-coupled processing device 410 to update AI model 402 (shown in FIG. 9 as update 604 to AI model 402); and portion 420 of training dataset 404 using network-coupled processing device 412 to update AI model 402 (shown in FIG. 9 as update 606 to AI model 402). In this example, storage optimization process 10 processes each portion (e.g., portions 414, 416, 418, 420) of training dataset 404 that have SLAs with increased priority levels. In this manner, storage optimization process 10 increases the priority of the training dataset's SLA so that the read performance can be maximized to achieve full network-coupled processing device utilization.

In some implementations and as discussed above, processing 706 training dataset 404 using network-coupled processing devices 400, 408, 410, 412 includes processing checkpoints (e.g., checkpoints 608, 610, 612, 614) generated for storage in network-coupled storage device 406.

In some implementations, storage optimization process 10 determines 710 that the processing of the training dataset is complete and decreases 712 the priority level associated with the SLA for the training dataset. For example, in response to completing the processing of each portion (e.g., portions 414, 416, 418, 420) of training dataset 404 from network-coupled storage device 406, network-coupled processing devices 400, 408, 410, 412 may provide a message (e.g., using an API) to network-coupled storage device 406 indicating that the processing of training dataset 404 is complete. In another example, network-coupled storage device 406 monitors the processing of training dataset 404 by network-coupled processing devices 400, 408, 410, 412 to determine 710 that the processing of training dataset 404 is complete. In response to determining 710 that training dataset 404 is complete, storage optimization process 10 decreases 712 the priority level associated with the SLA for the training dataset. For example, storage optimization process 10 may decrease 712 priority level 802 of SLA 800 for training dataset 404 in response to determining 710 that the processing of training dataset 404 is complete. In this manner, storage optimization process 10 returns training dataset 404 to its previous priority level for processing other workloads on network-coupled storage device 406.

### Pre-allocating Storage Capacity for Checkpoint Data

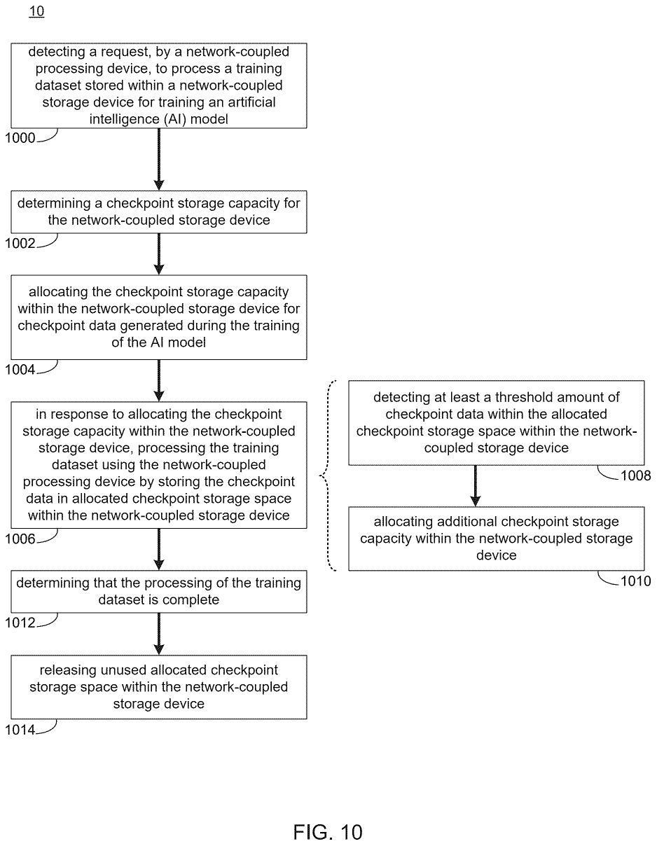

Referring also to FIGS. 10-12 and in some implementations, storage optimization process 10 detects 1000 a request, by a network-coupled processing device, to process a training dataset stored within a network-coupled storage device for training an artificial intelligence (AI) model. A checkpoint storage capacity for the network-coupled storage device is determined 1002. The checkpoint storage capacity is allocated 1004 within the network-coupled storage device for checkpoint data generated during the training of the AI model. In response to allocating the checkpoint storage capacity within the network-coupled storage device, the training dataset is processed 1006 using the network-coupled processing device by storing the checkpoint data in allocated checkpoint storage space within the network-coupled storage device.

In some implementations, storage optimization process 10 detects 1000 a request, by a network-coupled processing device, to process a training dataset stored within a network-coupled storage device for training an artificial intelligence (AI) model. As discussed above, a network-coupled processing device (e.g., network-coupled processing device 400) is used to train an artificial intelligence (AI) model (e.g., AI model 402) using a training dataset (e.g., training dataset 404) stored on a network-coupled storage device (e.g., network-coupled storage device 406).

In some implementations, the network-coupled processing device is a computing device that is communicatively coupled (e.g., via a network) to network-coupled storage device 406 and is configured to access training dataset 404 stored on network-coupled storage device 406. In some implementations, network-coupled processing device 400 is a Graphical Processing Unit (GPU). For example, GPUs are often used for training AI models due to their exceptional ability to handle the large-scale parallel processing required for deep learning tasks. GPUs are designed to perform numerous calculations simultaneously, making them ideal for the matrix and vector operations common in AI model training. This parallelism allows for faster computation compared to Central Processing Units (CPUs), which are optimized for sequential processing. Additionally, the architecture of GPUs enables them to process a large number of operations per second, crucial for managing the vast amounts of data involved in training complex AI models. They efficiently handle large datasets due to their high memory bandwidth and ability to perform multiple operations concurrently.

In some implementations, the training dataset is processed by a plurality of network-coupled processing devices. For example, when training AI model 402, storage optimization process 10 may use a cluster of network-coupled processing devices (e.g., network-coupled processing devices 400, 408, 410, 412) to train AI model 402 using training dataset 404 from network-coupled storage device 406. As will be discussed in greater detail below, each network-coupled processing device may be assigned to process a separate portion of training dataset 404. In one example, portion 414 may be assigned to network-coupled processing device 400; portion 416 may be assigned to network-coupled processing device 408; portion 418 may be assigned to network-coupled processing device 410; and portion 420 may be assigned to network-coupled processing device 412.

In some implementations, each network-coupled processing device interfaces with the network-coupled storage device using a separate storage controller. For example, network-coupled storage device 406 may define all of, or a portion of, a storage system as described above in FIG. 2 (e.g., storage system 12). As shown in the example of FIG. 4, network-coupled storage device 406 includes a plurality of storage controllers (e.g., storage controllers 422, 424, 426, 428). In some implementations, a storage controller is a hardware and/or software component that manages the processing of data into and out of network-coupled processing device. For example, storage controllers 422, 424, 426, 428 may include the same structure and functionality as storage processors 100, 126 as described above and as shown in FIG. 2. In some implementations, storage optimization process 10 assigns a separate storage controller to each network-coupled processing device. In the example of FIG. 4, storage optimization process 10 assigns storage controller 422 for interfacing with network-coupled processing device 400; storage controller 424 for interfacing with network-coupled processing device 408; storage controller 426 for interfacing with network-coupled processing device 410; and storage controller 428 for interfacing with network-coupled processing device 412. In some implementations, each storage controller includes a separate cache system for caching data with the structure and/or functionality as described above for cache 122, 128 for storage processors 100, 126.

In some implementations and as shown in FIG. 4, storage optimization process 10 detects 1000 a request, by a network-coupled processing device (e.g., network-coupled processing devices 400, 408, 410, 412), to process training dataset 404 for training the AI model. In one example, storage optimization process 10 processes the request using a scheduler that initiates an application programming interface (API) to notify network-coupled storage device 406 that the data under a specific filesystem directory contains the target training dataset. In the example of FIG. 4, network-coupled processing devices 400, 408, 410, 412 are shown providing requests (e.g., requests 430, 432, 434, 436) to process training dataset 404 of network-coupled storage device 406. It will be appreciated that network-coupled storage device 406 may receive a request from any number of network-coupled processing devices and/or other devices within a cluster of network-coupled processing devices to detect 1000 a request to process training dataset 404 within the scope of the present disclosure.

In some implementations, storage optimization process 10 determines 1002 a checkpoint storage capacity for the network-coupled storage device. For example, the size of AI model training checkpoints generated by network-coupled processing devices (e.g., network-coupled processing devices 400, 408, 410, 412) generally scales with the number of parameters of AI model 402. In one example with the assumption of fourteen bytes per model parameter, a single checkpoint for 520 billion parameter model would require about 7.5 terabytes (TB) of storage capacity. In this example, achieving 95% network-coupled process device utilization would require storing that 7.5 TB of data in about 180 seconds. To maximize write performance, checkpoint data may be written to one or more new files/objects (i.e., without overwriting or updating existing files/objects). Allocating storage capacity for these new files/objects can be a challenge for scale-out storage systems as it requires the storage controllers (e.g., storage controllers 422, 424, 426, 428) to communicate and coordinate the provisioning and reservation of any shared unused capacity. In some implementations, the coordination overhead can limit write performance, especially under heavy bursts of write activity like that which happens during the checkpointing of a large AI model.

In some implementations, storage optimization process 10 determines a total amount of storage capacity within network-coupled storage device 406 for storing checkpoint data. For example, storage optimization process 10 determines 1002 a checkpoint storage capacity for network-coupled storage device 406 as a function of the total amount of available storage capacity for storing new data within network-coupled storage device 406. In one example, checkpoint storage capacity for network-coupled storage device 406 is the total amount of available storage capacity in network-coupled storage device 406. In another example, checkpoint storage capacity for network-coupled storage device 406 is a threshold amount of the total amount of available storage capacity in network-coupled storage device 406 (e.g., threshold amounts including, but not limited to, 95% of the total amount of available storage capacity, 90% of the total amount of available storage capacity, 80% of the total amount of available storage capacity, 75% of the total amount of available storage capacity, 50% of the total amount of available storage capacity, etc.). It will be appreciated that any threshold or ratio of the total amount of available storage capacity may be used within the scope of the present disclosure to define the checkpoint storage capacity for network-coupled storage device 406.

In some implementations, storage optimization process 10 allocates 1004 the checkpoint storage capacity within the network-coupled storage device for checkpoint data generated during the training of the AI model. For example, storage optimization process 10 informs (e.g., using an AI training job training scheduler) network-coupled storage device 406 that one or more checkpoints of a given size will be stored under a specified file system path or object prefix. This allows network-coupled storage device 406 to pre-allocate storage capacity in advance to store the checkpoints and moves the overhead of provisioning this capacity outside of the write operation critical path thus improving latency and throughput. Accordingly, storage optimization process 10 allocates 1004 at least a portion of the checkpoint storage capacity within network-coupled storage device 406 by designating a portion of available storage capacity of network-coupled storage device 406 for storing checkpoints (e.g., checkpoints 608, 610, 612, 614) generated by network-coupled processing devices 400, 408, 410, 412 (e.g., allocated checkpoint storage space 1100). In some implementations, allocated checkpoint storage space 1100 is a pool of available storage space within network-coupled storage device 406 that is allocated for storing checkpoints.

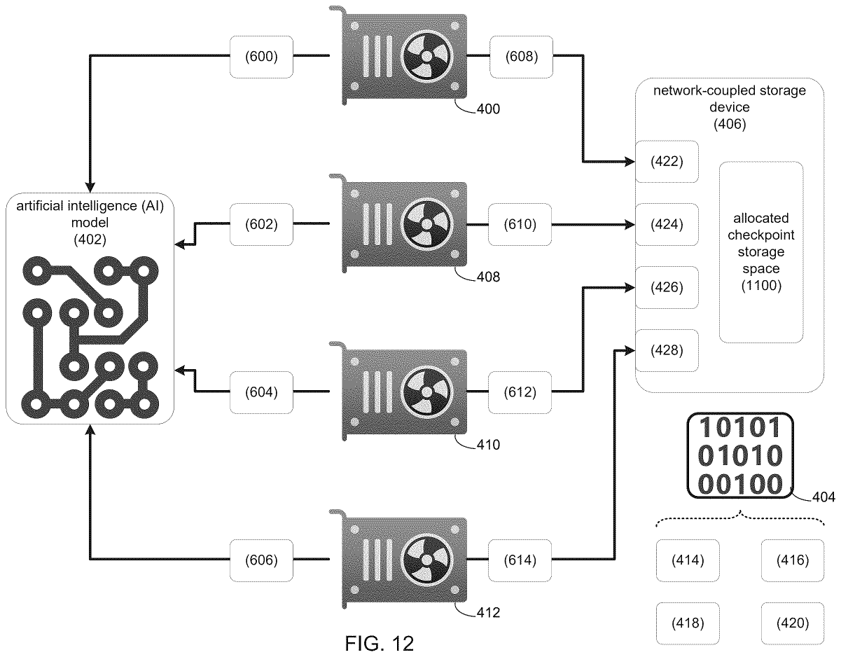

In some implementations and in response to allocating 1004 the checkpoint storage capacity within the network-coupled storage device, storage optimization process 10 processes 1006 the training dataset using the network-coupled processing device by storing the checkpoint data in allocated checkpoint storage space within the network-coupled storage device. Referring also to FIG. 12, storage optimization process 10 processes portion 414 of training dataset 404 using network-coupled processing device 400 to update AI model 402 (shown in FIG. 12 as update 600 to AI model 402); portion 416 of training dataset 404 using network-coupled processing device 408 to update AI model 402 (shown in FIG. 12 as update 602 to AI model 402); portion 418 of training dataset 404 using network-coupled processing device 410 to update AI model 402 (shown in FIG. 12 as update 604 to AI model 402); and portion 420 of training dataset 404 using network-coupled processing device 412 to update AI model 402 (shown in FIG. 12 as update 606 to AI model 402).

In some implementations and as discussed above, processing 1006 training dataset 404 using network-coupled processing devices 400, 408, 410, 412 includes processing checkpoints (e.g., checkpoints 608, 610, 612, 614) generated for storage in network-coupled storage device 406. In some implementations, processing 1006 the training dataset includes storing the checkpoint data (e.g., checkpoints 608, 610, 612, 614) in allocated checkpoint storage space 1100 within network-coupled storage device 406.

In some implementations, processing 1006 the training dataset using the network-coupled processing device includes detecting 1008 at least a threshold amount of checkpoint data within the allocated checkpoint storage space within the network-coupled storage device and allocating 1010 additional checkpoint storage capacity within the network-coupled storage device. For example, upon receiving checkpoints 608, 610, 612, 614 as write requests to network-coupled storage device 406 to write checkpoints 608, 610, 612, 614 to allocated checkpoint storage space 1100, storage optimization process 10 stores these checkpoints in the pool of pre-allocated storage. Storage optimization process 10 continually monitors the available storage capacity of allocated checkpoint storage space 1100. In some implementations, storage optimization process 10 detects 1008 at least a threshold amount of checkpoint data stored within allocated checkpoint storage space 1100. For example, the threshold amount of checkpoint data may be a threshold percentage of the total allocated checkpoint storage space that is occupied with checkpoint data. Accordingly, when the pre-allocated capacity is depleted (e.g., from detecting 1008 at least the threshold amount of or percentage of checkpoint data within allocated checkpoint storage space 1100), storage optimization process 10 allocates 1010 additional checkpoint storage capacity within network-coupled storage device 406 to replenish allocated checkpoint storage space in preparation for the next checkpoint.

In some implementations, storage optimization process 10 determines 1012 that the processing of the training dataset is complete and releases 1014 unused allocated checkpoint storage space within the network-coupled storage device. For example, in response to completing the processing of each portion (e.g., portions 414, 416, 418, 420) of training dataset 404 from network-coupled storage device 406, network-coupled processing devices 400, 408, 410, 412 may provide a message (e.g., using an API) to network-coupled storage device 406 indicating that the processing of training dataset 404 is complete. In another example, network-coupled storage device 406 monitors the processing of training dataset 404 by network-coupled processing devices 400, 408, 410, 412 to determine 1012 that the processing of training dataset 404 is complete. In response to determining 1012 that training dataset 404 is complete, storage optimization process 10 releases 1014 unused allocated checkpoint storage space 1100 within network-coupled storage device 406. For example, storage optimization process 10 may release 1014 at least a portion of unused allocated checkpoint storage space 1100 in network-coupled storage device 406 in response to determining 1012 that the processing of training dataset 404 is complete. In this manner, storage optimization process 10 returns unused allocated checkpoint storage space for storing data associated with the processing other workloads on network-coupled storage device 406.

### Temporarily Reducing Data Protection for Checkpoint Data

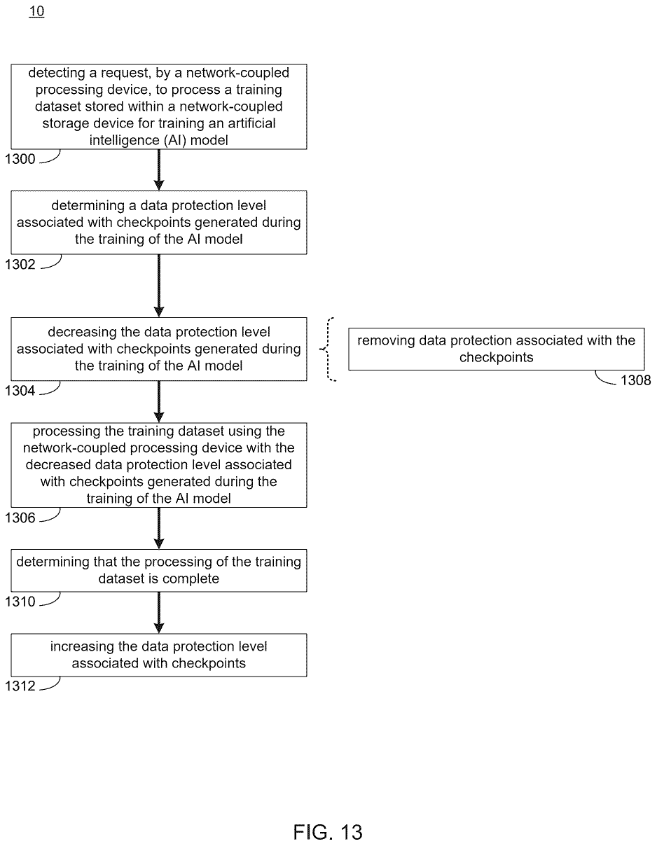

Referring also to FIGS. 13-15 and in some implementations, storage optimization process 10 detects 1300 a request, by a network-coupled processing device, to process a training dataset stored within a network-coupled storage device for training an artificial intelligence (AI) model. A data protection level associated with checkpoints generated during the training of the AI model is determined 1302. The data protection level associated with the checkpoints generated during the training of the AI model is decreased 1304. The training dataset is processed 1306 using the network-coupled processing device with the decreased data protection level associated with the checkpoints generated during the training of the AI model.

In some implementations, storage optimization process 10 detects 1300 a request, by a network-coupled processing device, to process a training dataset stored within a network-coupled storage device for training an artificial intelligence (AI) model. As discussed above, a network-coupled processing device (e.g., network-coupled processing device 400) is used to train an artificial intelligence (AI) model (e.g., AI model 402) using a training dataset (e.g., training dataset 404) stored on a network-coupled storage device (e.g., network-coupled storage device 406).

In some implementations, the network-coupled processing device is a computing device that is communicatively coupled (e.g., via a network) to network-coupled storage device 406 and is configured to access training dataset 404 stored on network-coupled storage device 406. In some implementations, network-coupled processing device 400 is a Graphical Processing Unit (GPU). For example, GPUs are often used for training AI models due to their exceptional ability to handle the large-scale parallel processing required for deep learning tasks. GPUs are designed to perform numerous calculations simultaneously, making them ideal for the matrix and vector operations common in AI model training. This parallelism allows for faster computation compared to Central Processing Units (CPUs), which are optimized for sequential processing. Additionally, the architecture of GPUs enables them to process a large number of operations per second, crucial for managing the vast amounts of data involved in training complex AI models. They efficiently handle large datasets due to their high memory bandwidth and ability to perform multiple operations concurrently.

In some implementations, the training dataset is processed by a plurality of network-coupled processing devices. For example, when training AI model 402, storage optimization process 10 may use a cluster of network-coupled processing devices (e.g., network-coupled processing devices 400, 408, 410, 412) to train AI model 402 using training dataset 404 from network-coupled storage device 406. As will be discussed in greater detail below, each network-coupled processing device may be assigned to process a separate portion of training dataset 404. In one example, portion 414 may be assigned to network-coupled processing device 400; portion 416 may be assigned to network-coupled processing device 408; portion 418 may be assigned to network-coupled processing device 410; and portion 420 may be assigned to network-coupled processing device 412.

In some implementations, each network-coupled processing device interfaces with the network-coupled storage device using a separate storage controller. For example, network-coupled storage device 406 may define all of, or a portion of, a storage system as described above in FIG. 2 (e.g., storage system 12). As shown in the example of FIG. 4, network-coupled storage device 406 includes a plurality of storage controllers (e.g., storage controllers 422, 424, 426, 428). In some implementations, a storage controller is a hardware and/or software component that manages the processing of data into and out of network-coupled processing device. For example, storage controllers 422, 424, 426, 428 may include the same structure and functionality as storage processors 100, 126 as described above and as shown in FIG. 2. In some implementations, storage optimization process 10 assigns a separate storage controller to each network-coupled processing device. In the example of FIG. 4, storage optimization process 10 assigns storage controller 422 for interfacing with network-coupled processing device 400; storage controller 424 for interfacing with network-coupled processing device 408; storage controller 426 for interfacing with network-coupled processing device 410; and storage controller 428 for interfacing with network-coupled processing device 412. In some implementations, each storage controller includes a separate cache system for caching data with the structure and/or functionality as described above for cache 122, 128 for storage processors 100, 126.

In some implementations and as shown in FIG. 4, storage optimization process 10 detects 1300 a request, by a network-coupled processing device (e.g., network-coupled processing devices 400, 408, 410, 412), to process training dataset 404 for training the AI model. In one example, storage optimization process 10 processes the request using a scheduler that initiates an application programming interface (API) to notify network-coupled storage device 406 that the data under a specific filesystem directory contains the target training dataset. In the example of FIG. 4, network-coupled processing devices 400, 408, 410, 412 are shown providing requests (e.g., requests 430, 432, 434, 436) to process training dataset 404 of network-coupled storage device 406. It will be appreciated that network-coupled storage device 406 may receive a request from any number of network-coupled processing devices and/or other devices within a cluster of network-coupled processing devices to detect 1300 the request to process training dataset 404 within the scope of the present disclosure.

In some implementations, storage optimization process 10 determines 1302 a data protection level associated with checkpoints generated during the training of the AI model. For example, enterprise storage systems use a variety of advanced technologies to protect against data corruption and loss. This may include various forms of mirroring, check summing, and erasure encoding across multiple independent storage media and controllers. To guarantee that data is reliably stored and protected, storage systems do not complete write requests until any such data protections are in place. The calculations and operations needed to protect data can require non-trivial time, especially in scale-out storage systems that may require communication between storage controllers to coordinate storing copies or stripes of the data across failure domains. This overhead of protecting data can significantly reduce or limit write performance.

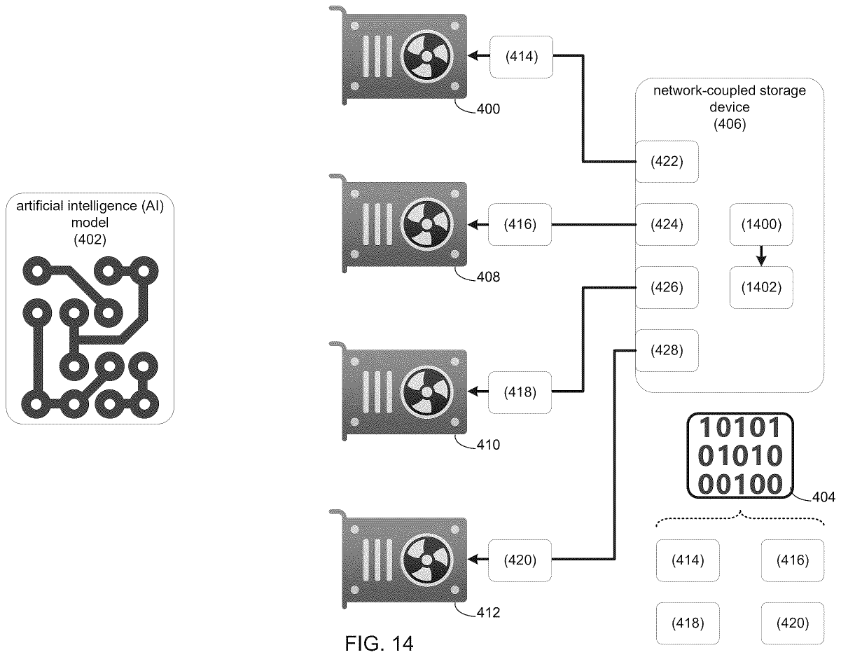

In some implementations and referring also to FIG. 14, storage optimization process 10 determines 1302 a data protection level (e.g., data protection level 1400) associated with the checkpoints that are generated during training of AI model 402. For example, storage optimization process 10 processes a destination (e.g., specified file system path) within network-coupled storage device 406 to determine the data protection level (if any) for the destination within network-coupled storage device 406. Examples of data protection levels include, but are not limited to, schemes or protocols used to prevent data loss due to unforeseen system or component failures. In one example, the data protection level includes a level of RAID protection (e.g., RAID1, RAID5, RAID6, etc.). In this example, a higher level of data protection includes a RAID configuration that provides more data protection while a lower level of data protection includes a RAID configuration that is more vulnerable to data loss or corruption. In another example, the data protection level includes a data encryption level. For example, the encryption of data may be a level of data protection while the absence of encryption provides no level of data protection. In yet another example, the data protection level includes the addition of data integrity checks (e.g., checksums and hash functions).

In some implementations, a lower level of data protection includes a scheme that protects against fewer system component failures but is capable of supporting higher levels of sustained write performance, through the avoidance of additional system operations needed to protect the data while a higher level of data protection includes a protection scheme that is able to protect against a greater number of system component failures that require more internal system operations to persistently and reliably store the information needed to recover the data in the case of component failures. Accordingly, it will be appreciated that various levels of data protection are possible within the scope of the present disclosure.

In some implementations, storage optimization process 10 decreases 1304 the data protection level associated with the checkpoints generated during the training of the AI model. For example, by disabling the data protection level for checkpoints generated during the training of AI model 402, storage optimization process 10 increases write performance to complete checkpoints faster and to minimize network-coupled processing device idleness. In some implementations, decreasing 1304 the data protection level (e.g., data protection level 1400 decreased to data protection level 1402) includes reducing a RAID configuration from a RAID configuration with a higher level of protection that is more computationally expensive (e.g., RAID6) to a RAID configuration with a lower level of protection that is less computationally expensive (e.g., RAID0). In another example, decreasing 1304 data protection level 1400 includes reducing an encryption level from a first encryption level to a lower, second encryption level.

In some implementations, decreasing 1304 the data protection level associated with the checkpoints includes removing 1308 data protection associated with the checkpoints. For example, storage optimization process 10 may remove data protection associated with data protection level 1400 associated with the checkpoints generated by network-coupled processing devices 400, 408, 410, 412. In one example, storage optimization process 10 removes data protection by removing a RAID configuration from checkpoints. In another example, storage optimization process 10 removes data encryption associated with the checkpoints. In this manner, storage optimization process 10 may maximize checkpoint writing efficiency by removing computational expenses associated with data protection.

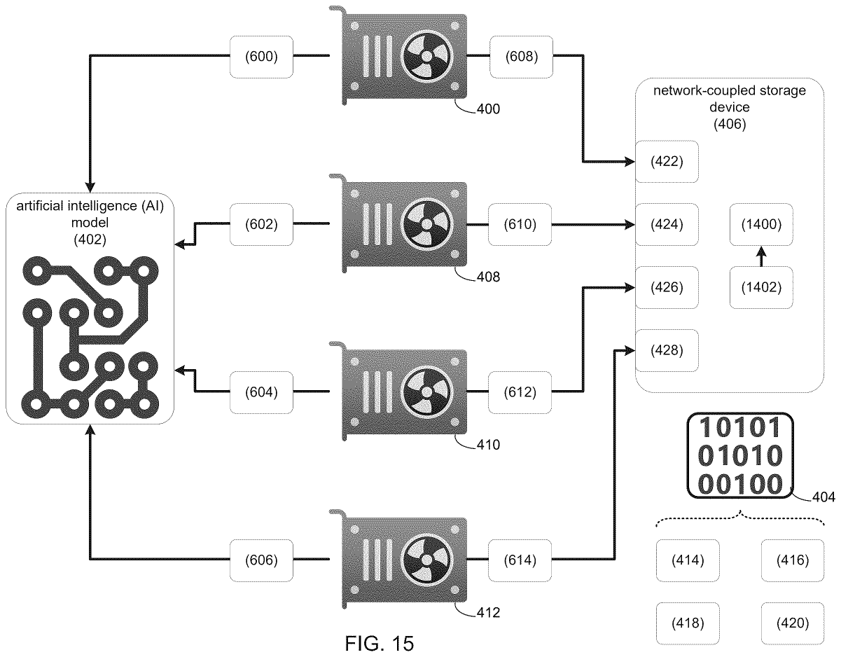

In some implementations, storage optimization process 10 processes the training dataset using the network-coupled processing device with the decreased data protection level associated with the checkpoints generated during the training of the AI model. Referring also to FIG. 15, storage optimization process 10 processes portion 414 of training dataset 404 using network-coupled processing device 400 to update AI model 402 (shown in FIG. 15 as update 600 to AI model 402); portion 416 of training dataset 404 using network-coupled processing device 408 to update AI model 402 (shown in FIG. 15 as update 602 to AI model 402); portion 418 of training dataset 404 using network-coupled processing device 410 to update AI model 402 (shown in FIG. 15 as update 604 to AI model 402); and portion 420 of training dataset 404 using network-coupled processing device 412 to update AI model 402 (shown in FIG. 15 as update 606 to AI model 402).

In some implementations and as discussed above, processing 1306 training dataset 404 using network-coupled processing devices 400, 408, 410, 412 includes processing checkpoints (e.g., checkpoints 608, 610, 612, 614) generated for storage in network-coupled storage device 406. For example, upon receiving write requests to store checkpoints 608, 610, 612, 614 to a specified file system path within network-coupled storage device 406, storage optimization process 10 stores the associated checkpoint with reduced or no data protection to complete the write operation as quickly as possible. In some implementations and at a later time after the checkpoint completes, storage optimization process 10 may add the data protection level necessary protection to guard against data corruption or loss.

In some implementations, storage optimization process 10 determines 1310 that the processing of the training dataset is complete and increases 1312 the data protection level associated with the checkpoints. For example, in response to completing the processing of each portion (e.g., portions 414, 416, 418, 420) of training dataset 404 from network-coupled storage device 406, network-coupled processing devices 400, 408, 410, 412 may provide a message (e.g., using an API) to network-coupled storage device 406 indicating that the processing of training dataset 404 is complete. In another example, network-coupled storage device 406 monitors the processing of training dataset 404 by network-coupled processing devices 400, 408, 410, 412 to determine 1310 that the processing of training dataset 404 is complete. In response to determining 1310 that training dataset 404 is complete, storage optimization process 10 increases 1312 data protection level 1402 associated with the checkpoints back to data protection level 1400. For example and as discussed above, storage optimization process 10 may, after the training of AI model 402 is completed, add the data protection previously reduced to prevent or limit data loss.

In some implementations, storage optimization process 10 increases the data protection level associated with the checkpoints on a checkpoint-basis. For example, the data protection level may be increased after each checkpoint is finished being saved. Accordingly, future checkpoints for the same AI training job may again be saved initially at a lower level of protection and then protected with a higher level of protection after the checkpoints are done being saved.

### Migrating Checkpoint Data with Multi-Tier Data Storage

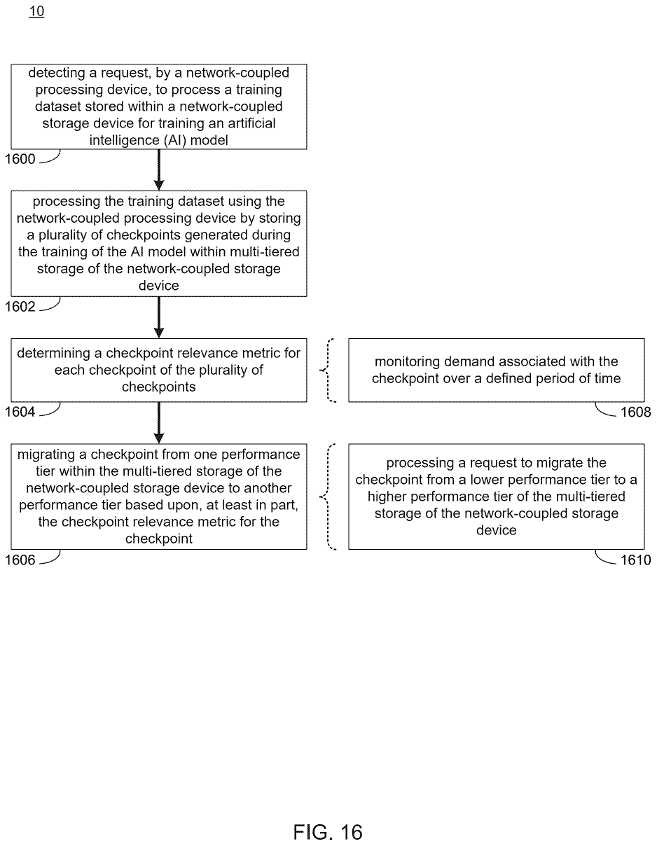

Referring also to FIGS. 16-18 and in some implementations, storage optimization process 10 detects 1600 a request, by a network-coupled processing device, to process a training dataset stored within a network-coupled storage device for training an artificial intelligence (AI) model. The training dataset is processed 1602 using the network-coupled processing device by storing a plurality of checkpoints generated during the training of the AI model within multi-tiered storage of the network-coupled storage device. A checkpoint relevance metric is determined 1604 for each checkpoint of the plurality of checkpoints. A checkpoint is migrated 1606 from one performance tier within the multi-tiered storage of the network-coupled storage device to another performance tier based upon, at least in part, the checkpoint relevance metric for the checkpoint.

In some implementations, storage optimization process 10 detects 1600 a request, by a network-coupled processing device, to process a training dataset stored within a network-coupled storage device for training an artificial intelligence (AI) model. As discussed above, a network-coupled processing device (e.g., network-coupled processing device 400) is used to train an artificial intelligence (AI) model (e.g., AI model 402) using a training dataset (e.g., training dataset 404) stored on a network-coupled storage device (e.g., network-coupled storage device 406).

In some implementations, the network-coupled processing device is a computing device that is communicatively coupled (e.g., via a network) to network-coupled storage device 406 and is configured to access training dataset 404 stored on network-coupled storage device 406. In some implementations, network-coupled processing device 400 is a Graphical Processing Unit (GPU). For example, GPUs are often used for training AI models due to their exceptional ability to handle the large-scale parallel processing required for deep learning tasks. GPUs are designed to perform numerous calculations simultaneously, making them ideal for the matrix and vector operations common in AI model training. This parallelism allows for faster computation compared to Central Processing Units (CPUs), which are optimized for sequential processing. Additionally, the architecture of GPUs enables them to process a large number of operations per second, crucial for managing the vast amounts of data involved in training complex AI models. They efficiently handle large datasets due to their high memory bandwidth and ability to perform multiple operations concurrently.

In some implementations, the training dataset is processed by a plurality of network-coupled processing devices. For example, when training AI model 402, storage optimization process 10 may use a cluster of network-coupled processing devices (e.g., network-coupled processing devices 400, 408, 410, 412) to train AI model 402 using training dataset 404 from network-coupled storage device 406. As will be discussed in greater detail below, each network-coupled processing device may be assigned to process a separate portion of training dataset 404. In one example, portion 414 may be assigned to network-coupled processing device 400; portion 416 may be assigned to network-coupled processing device 408; portion 418 may be assigned to network-coupled processing device 410; and portion 420 may be assigned to network-coupled processing device 412.

In some implementations, each network-coupled processing device interfaces with the network-coupled storage device using a separate storage controller. For example, network-coupled storage device 406 may define all of, or a portion of, a storage system as described above in FIG. 2 (e.g., storage system 12). As shown in the example of FIG. 4, network-coupled storage device 406 includes a plurality of storage controllers (e.g., storage controllers 422, 424, 426, 428). In some implementations, a storage controller is a hardware and/or software component that manages the processing of data into and out of network-coupled processing device. For example, storage controllers 422, 424, 426, 428 may include the same structure and functionality as storage processors 100, 126 as described above and as shown in FIG. 2. In some implementations, storage optimization process 10 assigns a separate storage controller to each network-coupled processing device. In the example of FIG. 4, storage optimization process 10 assigns storage controller 422 for interfacing with network-coupled processing device 400; storage controller 424 for interfacing with network-coupled processing device 408; storage controller 426 for interfacing with network-coupled processing device 410; and storage controller 428 for interfacing with network-coupled processing device 412. In some implementations, each storage controller includes a separate cache system for caching data with the structure and/or functionality as described above for cache 122, 128 for storage processors 100, 126.

In some implementations and as shown in FIG. 4, storage optimization process 10 detects 1600 a request, by a network-coupled processing device (e.g., network-coupled processing devices 400, 408, 410, 412), to process training dataset 404 for training the AI model. In one example, storage optimization process 10 processes the request using a scheduler that initiates an application programming interface (API) to notify network-coupled storage device 406 that the data under a specific filesystem directory contains the target training dataset. In the example of FIG. 4, network-coupled processing devices 400, 408, 410, 412 are shown providing requests (e.g., requests 430, 432, 434, 436) to process training dataset 404 of network-coupled storage device 406. It will be appreciated that network-coupled storage device 406 may receive a request from any number of network-coupled processing devices and/or other devices within a cluster of network-coupled processing devices to detect 1600 the request to process training dataset 404 within the scope of the present disclosure.

In some implementations, storage optimization process 10 processes 1602 the training dataset using the network-coupled processing device by storing a plurality of checkpoints generated during the training of the AI model within multi-tiered storage of the network-coupled storage device. For example, training large AI models can require weeks or months of computation. During training, checkpoints are frequently taken to enable the resumption of training after a planned or unplanned disruption. This process can lead to a large amount of accumulated checkpoint data. For example, assuming fourteen bytes per model parameter, a single checkpoint for a 520 billion parameter model would require about 7.5 TB of storage capacity. If such a model were trained for 28 days with the checkpoints taken at 1-hour intervals, over 5 petabytes of storage capacity would be needed to store the resulting 672 checkpoints.

Model training is typically paused while a checkpoint is saved leaving valuable network-coupled processing device resources idle. Therefore, saving checkpoints as quickly as possible minimizes wasted computing resources over time. To achieve high speed storage, checkpoint data may be stored on costly high-performance storge media like storage class memory or solid state storge. However, once saved, a checkpoint is only used if there is a need to resume model training from that specific point in time. The probability of a checkpoint being used to resume training decreases over time as the checkpoint ages. Accordingly, most checkpoints go unused and, if left in place, needlessly consume high performance storage media capacity that could be used for other purposes.

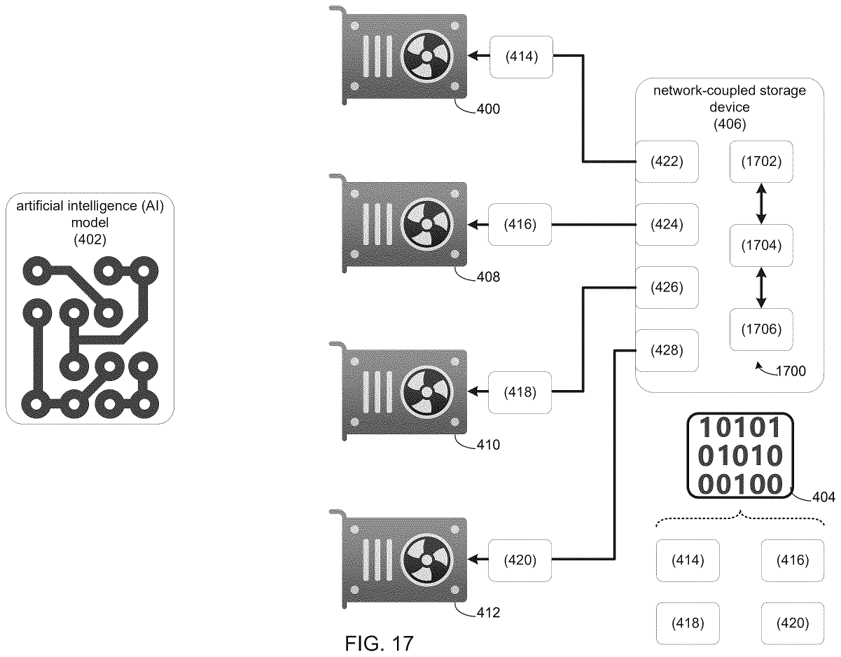

In some implementations, storage optimization process 10 provides multi-tiered storage (e.g., multi-tiered storage 1700) within network-coupled storage device 406 for storing checkpoints. A multi-tiered storage (e.g., multi-tiered storage 1700) is a configuration of multiple storage devices or types of storage that have varying levels of performance. Data stored on one performance tier may be moved to different tiers based on the demand. For example, data subject to a higher demand can be read and/or written to more effectively using a higher performance storage media (i.e., a higher performance storage tier) while data that is subject to low demand can be read and/or written to more slowly using a lower performance storage tier (i.e., a lower performance storage tier) without impacting the performance of network-coupled storage device 406. In some implementations, the multi-tiered storage of the network-coupled storage device includes a dynamic random-access memory (DRAM) storage tier, a solid-state storage tier, and a hard drive storage tier. In the example of FIG. 17, multi-tiered storage 1700 includes a high-performance storage tier (e.g., DRAM storage tier 1702); a mid performance storage tier (e.g., solid state drive storage tier 1704); and a low performance storage tier (e.g., hard drive storage tier 1706). While specific examples of storage media with different performance levels have been described for three tiers, it will be appreciated that multi-tiered storage 1700 may include any number of storage tiers with various types of storage media within the scope of the present disclosure.

In some implementations, storage optimization process 10 determines 1604 a checkpoint relevance metric for each checkpoint of the plurality of checkpoints. For example, a checkpoint relevance metric is a measure of the temporality of the checkpoint. In one example, the checkpoint relevance metric includes a timestamp of the generation of the checkpoint. For instance, when checkpoint 608 is generated by network-coupled processing device 400, network-coupled processing device 400 or network-coupled storage device 406 may generate a timestamp for checkpoint 608. In some implementations, storage optimization process 10 may generate a checkpoint relevance metric as a function of the timestamp of checkpoint 608. For example, storage optimization process 10 may use a threshold to determine that a checkpoint is newer and therefore has a first checkpoint relevance metric associated with the newest checkpoints. Similarly, storage optimization process 10 may use a threshold to determine that a checkpoint is recent but no longer new and therefore has a second checkpoint relevance metric associated with the recent checkpoints. Additionally, storage optimization process 10 may use a threshold to determine that a checkpoint is old and therefore has a third checkpoint relevance metric associated with the older checkpoints. While an example of three checkpoint relevance metrics has been described, it will be appreciated that any number of thresholds may be used to define various checkpoint relevance metrics within the scope of the present disclosure.

In some implementations, determining 1604 the checkpoint relevance metric for each checkpoint of the plurality of checkpoints includes monitoring 1608 demand associated with the checkpoint over a defined period of time. For example, a checkpoint relevance metric may define a demand associated with a checkpoint. In this example, storage optimization process 10 may actively monitor how much a checkpoint is being accessed to determine 1607 the checkpoint relevance metric. In some implementations, checkpoint relevance metrics may define, or be a part of, a tiering policy within multi-tiered storage 1700 that guides how checkpoints are migrated from one performance tier to another. In some implementations, the defined period of time for monitoring 1608 demand associated with each checkpoint may be a default value, a user-defined value (e.g., using a graphical user interface), and/or a value determined heuristically by storage optimization process 10.

In some implementations, storage optimization process 10 migrates 1606 a checkpoint from one performance tier within the multi-tiered storage of the network-coupled storage device to another performance tier based upon, at least in part, the checkpoint relevance metric for the checkpoint. For example, as checkpoints are saved, storage optimization process 10 uses the checkpoint relevance metrics for each checkpoint and a tiering policy to automatically migrate checkpoint data to increasingly lower tiers of storage. In this example, the most recent checkpoints are be stored on higher performance tiers (e.g., high performance storage tier 1702 of multi-tiered storage 1700) for timely access while older checkpoints are migrated over time based on their checkpoint relevance metric to lower cost optimized tiers of storage (e.g., mid performance storage tier 1704 or low performance storage tier 1706). In some implementations, storage optimization process 10 uses a tiering policy to direct the migration of checkpoints to increasingly lower tiers of multi-tiered storage 1700 over time using their respective checkpoint relevance metrics. In one example, as a checkpoint ages, the checkpoint relevance metric may be a fixed value (e.g., a timestamp) that is used to migrate the checkpoint from high performance storage tier 1702 to mid performance storage tier 1704 and, eventually, to low performance storage tier 1706. In another example, storage optimization process 10 updates checkpoint relevance metrics based on demand to determine whether or not to migrate the checkpoint from one performance tier to another.

In some implementations, migrating 1606 the checkpoint from one performance tier within the multi-tiered storage of the network-coupled storage device to another performance tier includes processing 1610 a request to migrate the checkpoint from a lower performance tier to a higher performance tier of the multi-tiered storage of the network-coupled storage device. For example, storage optimization process 10 generates and processes requests to migrate 1606 a checkpoint from a lower performance tier to a higher performance tier. In one example, suppose that a checkpoint in lower performance storage is needed to resume training of AI model 402 (e.g., after a failure of a component of network-coupled storage device 406, a scheduled pause in training AI model 402, etc.). In this example, storage optimization process 10 processes a request to migrate the checkpoint from a lower performance tier (e.g., low performance tier 1706) to a higher performance tier (e.g., high performance tier 1702). In another example and as discussed above, a checkpoint relevance metric for a checkpoint may indicate that a checkpoint is in demand by a particular network-coupled processing device. In this example, storage optimization process 10 automatically promotes the relevant checkpoint to a higher performance tier to meet the demand.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
detecting a request, by a network-coupled processing device, to process a training dataset stored within a network-coupled storage device for training an artificial intelligence (AI) model;
processing the training dataset using the network-coupled processing device by storing a plurality of checkpoints generated during the training of the AI model within multi-tiered storage of the network-coupled storage device;
determining a checkpoint relevance metric for each checkpoint of the plurality of checkpoints; and
migrating a checkpoint from one performance tier within the multi-tiered storage of the network-coupled storage device to another performance tier based upon, at least in part, the checkpoint relevance metric for the checkpoint.

2. The computer-implemented method of claim 1, wherein the training dataset is processed by a plurality of network-coupled processing devices.

3. The computer-implemented method of claim 2, wherein each network-coupled processing device interfaces with the network-coupled storage device using a separate storage controller.

4. The computer-implemented method of claim 2, wherein each network-coupled processing device is a Graphical Processing Unit (GPU).

5. The computer implemented method of claim 1, wherein migrating the checkpoint from one performance tier within the multi-tiered storage of the network-coupled storage device to another performance tier includes processing a request to migrate the checkpoint from a lower performance tier to a higher performance tier of the multi-tiered storage of the network-coupled storage device.

6. The computer implemented method of claim 1, wherein determining the checkpoint relevance metric for each checkpoint of the plurality of checkpoints includes monitoring demand associated with the checkpoint over a defined period of time.

7. The computer implemented method of claim 1, wherein the multi-tiered storage of the network-coupled storage device includes a dynamic random-access memory (DRAM) storage tier, a solid-state storage tier, and a hard drive storage tier.

8. A computer program product residing on a non-transitory computer readable medium having a plurality of instructions stored thereon which, when executed by a processor, cause the processor to perform operations comprising:
detecting a request, by a network-coupled processing device, to process a training dataset stored within a network-coupled storage device for training an artificial intelligence (AI) model;
processing the training dataset using the network-coupled processing device by storing a plurality of checkpoints generated during the training of the AI model within multi-tiered storage of the network-coupled storage device;
determining a checkpoint relevance metric for each checkpoint of the plurality of checkpoints; and
migrating a checkpoint from one performance tier within the multi-tiered storage of the network-coupled storage device to another performance tier based upon, at least in part, the checkpoint relevance metric for the checkpoint.

9. The computer program product of claim 8, wherein the training dataset is processed by a plurality of network-coupled processing devices.

10. The computer program product of claim 9, wherein each network-coupled processing device interfaces with the network-coupled storage device using a separate storage controller.

11. The computer program product of claim 9, wherein each network-coupled processing device is a Graphical Processing Unit (GPU).

12. The computer program product of claim 8, wherein migrating the checkpoint from one performance tier within the multi-tiered storage of the network-coupled storage device to another performance tier includes processing a request to migrate the checkpoint from a lower performance tier to a higher performance tier of the multi-tiered storage of the network-coupled storage device.

13. The computer program product of claim 8, wherein determining the checkpoint relevance metric for each checkpoint of the plurality of checkpoints includes monitoring demand associated with the checkpoint over a defined period of time.

14. The computer program product of claim 8, wherein the multi-tiered storage of the network-coupled storage device includes a dynamic random-access memory (DRAM) storage tier, a solid-state storage tier, and a hard drive storage tier.

15. A computing system comprising:
a memory; and
a processor configured to detect a request, by a network-coupled processing device, to process a training dataset stored within a network-coupled storage device for training an artificial intelligence (AI) model, to process the training dataset using the network-coupled processing device by storing a plurality of checkpoints generated during the training of the AI model within multi-tiered storage of the network-coupled storage device, to determine a checkpoint relevance metric for each checkpoint of the plurality of checkpoints, and to migrate a checkpoint from one performance tier within the multi-tiered storage of the network-coupled storage device to another performance tier based upon, at least in part, the checkpoint relevance metric for the checkpoint.

16. The computing system of claim 15, wherein the training dataset is processed by a plurality of network-coupled processing devices.

17. The computing system of claim 16, wherein each network-coupled processing device interfaces with the network-coupled storage device using a separate storage controller.

18. The computing system of claim 16, wherein each network-coupled processing device is a Graphical Processing Unit (GPU).

19. The computing system of claim 15, wherein migrating the checkpoint from one performance tier within the multi-tiered storage of the network-coupled storage device to another performance tier includes processing a request to migrate the checkpoint from a lower performance tier to a higher performance tier of the multi-tiered storage of the network-coupled storage device.

20. The computing system of claim 15, wherein determining the checkpoint relevance metric for each checkpoint of the plurality of checkpoints includes monitoring demand associated with the checkpoint over a defined period of time.
